(19) United States
(12) Patent Application Publication
(10) Pub. No.: US 2011/0225008 A1
(43) Pub. Date: Sep. 15, 2011

(54) Self-Similar Medical Communications System

(75) Inventors: Nabil A. Elkouh, Enfield, NH (US); Gregory S. Fallon, Hanover, NH (US); Robert Harwood, Grantham, NH (US); Matthew J. Miller, Hanover, NH (US)

(73) Assignee: RESPIRA DV, LLC, Enfield, NH (US)

(21) Appl. No.: 12/720,270

(22) Filed: Mar. 9, 2010

(51) Int. Cl. G06Q 50/00; G06F 17/30; G06F 21/00; G01S 19/42; G06Q 10/00; G08B 1/08

(52) U.S. Cl. 705/3; 707/741; 726/4; 342/357.25; 705/2; 340/539.12; 707/E17.083

(57) ABSTRACT

A health care monitoring system and network for monitoring a patient's use of medications, physiological conditions, and/or the environment around the patient. The system takes advantage of a hierarchical nodal network to allow for the transfer of information from sensors to authorized users of the network while providing personal control of sensitive information and providing a distributed database structure for increased data security. In one embodiment, sensors transmit information to wearable personal data recorders that use a combination of random access and overwriting to store information in a time-sequenced organization.

### FIELD OF THE INVENTION

The present invention generally relates to the field of medical monitoring systems. In particular, the present invention is directed to a self-similar medical communications system.

### BACKGROUND

Monitoring, recording, and analyzing data, especially health-related data, is of increasing importance, as it is understood that if properly utilized, patient adherence to a prescribed treatment regimen can be improved and/or proactive modification of an unsuccessful treatment regimen can take place. While medical monitoring devices, such as heart monitors and the like have been in use for quite some time, improvements in and increasing numbers of medical monitoring devices, as well as the preference for electronic records, have created correspondingly growing needs for efficient mechanisms by which to collect, store, protect, and share information.

To date, medical monitoring equipment has been implemented primarily in point-to-point communications systems. In such systems, the source of the medical information and the destination for that information exchange data either over a dedicated connection between the two or over a general-purpose network implementing the Internet Protocol Suite, commonly known as “TCP/IP,” that exchanges the data between the two. More recent technologies have expanded upon the direct communication concept to allow various “multicast” or “publish/subscribe” capabilities for the delivery of medical information from medical sensors to multiple destinations. The aforementioned protocols generally make the information gathered by a medical information sensor available to multiple requestors by placing the information in a repository with either a unique sensor address or sensor subject identifier attached to the information. Thus, multiple requestors can either coincidentally ask for the medical information associated with the sensor address (multicast system) or all the sensor information associated with the subject (publish/subscribe system).

Whereas multicast and publish-subscribe approaches provide sensor information to multiple requestors (one-to-many capability), the inverse is not generally true. That is, a system having multiple sensors, but one requestor, has additional complexity and requirements. Furthermore, a more useful system is one that provides multiple-sensor-to-multiple-requestor capabilities, thus allowing for monitoring a multitude of persons performing a variety of physical actions or experiencing physiological or environmental conditions by many interested parties. The interested parties may include the patient, and/or the patient's family, doctors, hospitals, researchers, etc. However, under current conditions, a system having these capabilities requires exponential growth in the number of network connections (and in network bandwidth) and large databases, which makes accessing data inefficient and potentially risks possible disclosure of large amounts of sensitive information.

Thus, the management of a multitude of sensor data streams for access by multiple requestors presents major processing, communication, and administrative challenges. More specifically, medical monitoring applications demand scalable and secure support for data acquisition, data stream management, and data analysis and visualization. Currently, most applications address these issues by building custom systems that are invariably complex and difficult to support. Extensibility, scalability, and interoperability are often sacrificed and, generally, the patient loses control over their data. This lost control not only subjects the patient to increased risk that their health information may be wrongly disseminated, but it also leads to a patient's reluctance to implement a monitoring system when the patient cannot review or control his or her own information.

### SUMMARY OF THE DISCLOSURE

A medical communications system, comprising: a self-similar nodal network having a plurality of time-sequenced databases arranged in a hierarchical structure and communicatively interconnected with one another, the time-sequenced databases having information that is indexed by unique identifier and time, wherein the self-similar nodal network includes: a plurality of patient sensors, wherein each of the plurality of patient sensors is configured for detecting an action by a corresponding object associated with that one of the patient sensors and for generating, in response to the detecting, a corresponding signal, wherein the corresponding signal contains a record that includes 1) a time of an occurrence of the action and 2) a unique identifier for the corresponding one of the plurality of patient sensors; and a plurality of wearable personal data recorders, wherein each of the plurality of wearable personal data recorders includes a corresponding time-sequenced database of the plurality of time-sequenced databases and is configured to store the record in time sequence within the first time-sequenced database.

A method of monitoring an action of a user, the method comprising: receiving a first signal that contains a first record including a time of a first occurrence initiated by a user and a unique identifier; storing the first record in time sequence in a time-sequenced database of a wearable personal data recorder worn by the user, wherein the time of the occurrence and the unique identifier are indexed by the time of the occurrence and the unique identifier; receiving a second signal that contains a second record including a time of a second occurrence initiated by a user and a unique identifier; and organizing the first record and the second record according to a common time series.

A method of retrieving a patient record collected from a wearable personal data recorder via a patient sensor, comprising: communicatively connecting to a self-similar nodal network that includes a plurality of time-sequence database nodes, wherein the patient record is stored in the self-similar nodal network; issuing a retrieve command for the patient record to the self-similar nodal data network so as to cause the self-similar nodal network to retrieve the patient record from among the plurality of time-sequence database nodes; and retrieving the patient record via a nodal chain that includes at least three of the plurality of time-sequence database nodes.

A machine-readable storage medium containing machine-executable software instructions for performing a method of retrieving a patient record collected from a wearable personal record recorder via a patient sensor, the machine-executable software instructions comprising: a first set of machine-executable instructions for connecting to a self-similar data nodal network that includes a plurality of time-sequence database nodes, wherein the patient record is stored in the self-similar nodal network; a second set of machine-executable instructions for issuing a retrieve command for the patient record to the self-similar nodal network so as to cause the self-similar nodal network to retrieve the patient record from among the plurality of time-sequence database nodes; and a third set of machine-executable instructions for retrieving the patient record via a nodal chain that includes at least three of the plurality of time-sequence database nodes.

A wearable personal data recorder for relaying patient sensor information, the wearable personal data recorder comprising: a processor; a memory in communication with the processor, the memory containing a time-sequence database and storing a set of instructions executable by the processor for making the wearable personal data recorder a node in a hierarchical self-similar nodal network; and a transceiver in communication with the processor, the transceiver responsive to the set of instructions and the processor; wherein the set of machine-readable instructions configures the wearable personal data recorder to: receive a signal from the adherence sensor, wherein the signal includes a record; synchronize the record with the time-sequence database; and store the record in the memory.

A method of distributing wearable personal data recorders for a hierarchical self-similar nodal network comprising: distributing to a wireless device a set of instructions, wherein the set of instructions configure the wireless device to: receive a record into a time-sequence database; synchronize the record with the time-sequence database according to common time sequence; receive a request for the record from a record requestor; authorize the release of the record to the record requestor; transmit the record from the wireless device to the record requestor; and linking the wireless device to a patient sensor that is operatively coupled to a medical device and generates a signal in response to a user performing actions on the medical device, wherein the signal contains the record.

A method, comprising: implementing a medical regime adherence monitoring system for monitoring adherence of one or more people to corresponding respective medical regimes requiring that actions be taken by the one or more people, the implementing the medical regime adherence monitoring system including: establishing a hierarchical self-similar nodal network of time-sequence databases; and providing each person of the one or more people with a wearable personal data recorder configured: as a self-similar node on the hierarchical self-similar nodal network so as to contain a corresponding time-sequence database of the time-sequence databases; to receive user-action signals from a patient sensor that is operatively coupled to a medical device and generates the user-action signals in response to the that person performing actions on the medical device; to store in the corresponding time-sequence database, in response to the receipt of the user-action signals, occurrence data corresponding to the actions; to authorize requests for the occurrence data made over the hierarchical self-similar nodal network; and to transmit, in response to an authorized request, the occurrence data to another node of the hierarchical self-similar nodal network.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a high-level schematic diagram of a self-similar medical communications system according to an embodiment of the present invention;

FIG. 2 is a high-level schematic diagram of a multi-node time-sequence database (TSdB) structure according to an embodiment of the present invention;

FIG. 3 is a schematic diagram of the storage structure of a TSdB according to an embodiment of the present invention;

FIG. 4 is a high-level schematic diagram of a data-node mirroring operation according to an embodiment of the present invention;

FIG. 5 is a partial prospective view/partial block diagram of a wearable personal data recorder (WPDR) in communication with an adherence sensor according to an embodiment of the present invention;

FIG. 6 is a schematic diagram of a self-similar data network according to an embodiment of the present invention; and

FIG. 7 is a high-level diagram of a computing environment.

### DETAILED DESCRIPTION

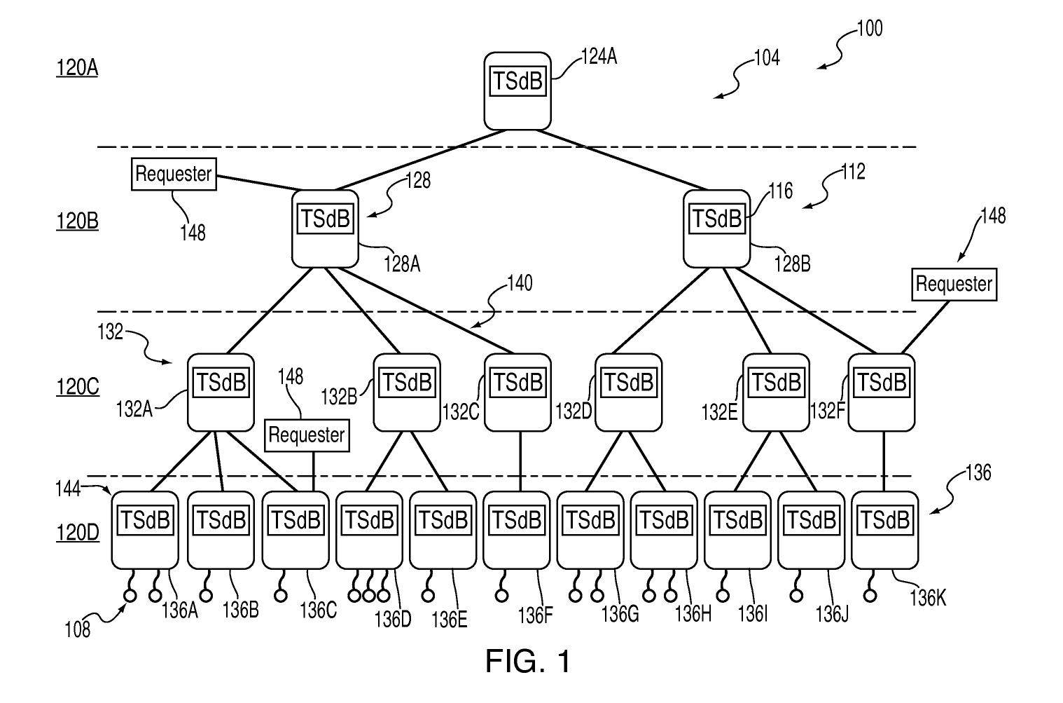

Referring now to the drawings, FIG. 1 illustrates an exemplary medical communications system 100 that implements a self-similar nodal network 104 to provide an efficient and highly scalable architecture for collecting, storing, transmitting, requesting, and retrieving various types of personal medical-related information concerning patients that utilize the system. This information is initially collected using one or more of various types of patient sensors 108, which include medical-regime-adherence sensors, physiological sensors, environmental sensors, and location sensors, that sense and/or measure various user actions and/or other things. It is noted that sensors 108 are denoted “patient” sensors to indicate that they are used to collect information relating to particular medical patients that are utilizing system 100. As will become apparent from reading this entire disclosure, a medical communications system of the present disclosure, such as system 100 of FIG. 1, can be used for a variety of purposes. For example, in one application system 100 can be used to assist patients in monitoring their efforts to comply with one or more medical treatment programs prescribed by one or more physicians and can allow for physician intervention if the prescribed regime is not being followed. Other uses are described below and still others will become apparent to the reader after reading and understanding this entire disclosure.

Self-similar nodal network 104 has a hierarchical data communication architecture primarily composed of a plurality of communicatively interconnected nodes, here nodes 112, each having a corresponding time-sequenced database (TSdB) 116 and each being capable of receiving information from one or more patient sensors 108 directly and/or through one or more others of nodes 112. In this example, nodes 112 are organized within a plurality of hierarchical levels, here levels 120A-D. Each level 120A-D has one or more nodes corresponding to that level; in this example, node 124A resides on level 120A, nodes 128A-B reside on level 120B, nodes 132A-F reside on level 120C, and nodes 136A-K reside on level 120D). Nodes 112, as will be described further below, may be, or include, a computer, personal digital assistant (PDA), server, or other device configured to receive, store, and output records (or, more generally, information) on network 104. In this example, nodes 112 on level 120D are typically wearable personal data recorders (WPDRs) 144, each of which directly collects information from one or more patient sensors 108 associated with that WPDR and stores that information in its TSdB 116. Nodes 112, including WPDRs 144, are connected to other nodes 120 via network communication links 140, each of which can be almost any data network link, including an Internet link, an intranet link, a link of a 3G network or other telecom network, as well as a local network link that uses protocols and communication methodologies known in the art. Information stored in network 104 can be accessed by one or more requestor applications 148, which may access nodal network 104 under certain predefined circumstances and conditions (described further below).

System 100 can be configured to collect information on one or more actions of each patient, one or more conditions of that patient, one or more conditions around that patient, and/or that patient's location, via one or more patient sensors 108, and to store that information in TSdBs 116 of one or more nodes 112 of nodal network 104, which effectively forms a distributed database. The information stored in TSdBs 116 can be accessed by an interested party through one or more of nodes 112 on the self-similar nodal network 104 via one or more corresponding requestor applications 148. For example, any one of WPDRs 144 can receive information from one or more corresponding patient sensors 108, and that information can be queried by at least one of requestor applications 148 at a higher node, for example, node 124A, via intermediate nodes 128A and 132A in network 100. As will become apparent, each requester application 148 can be implemented on any suitable device, such as a server, personal computer, cell phone, smartphone, personal digital assistant (PDA), etc., and used by one or more authorized third parties, such as hospitals, physicians, or other interested entities, over self-similar nodal network 104.

For convenience, each of the communicatively interconnected nodes 112 may be designated as a member of a family hierarchy, for example, as a parent node, a child node or a sibling node. The use of a familial naming convention allows for the description of the relative location of a node 112 within the hierarchy with respect to other nodes in the network. Thus, when a node is connected to and placed hierarchically above another node, it is a parent node, for example, node 124A is a parent node to node 128A. Correspondingly, when a node is connected to and placed hierarchically below another node, it is a child node, for example, node 132A is a child node to node 128A. Predictably, a node may concomitantly be a child node and a parent node. For instance, node 128A is a parent node to node 132A and node 128A is a child node to node 124A. Nodes that share the same parent are sibling nodes. For example, node 132A and node 132B are sibling nodes.

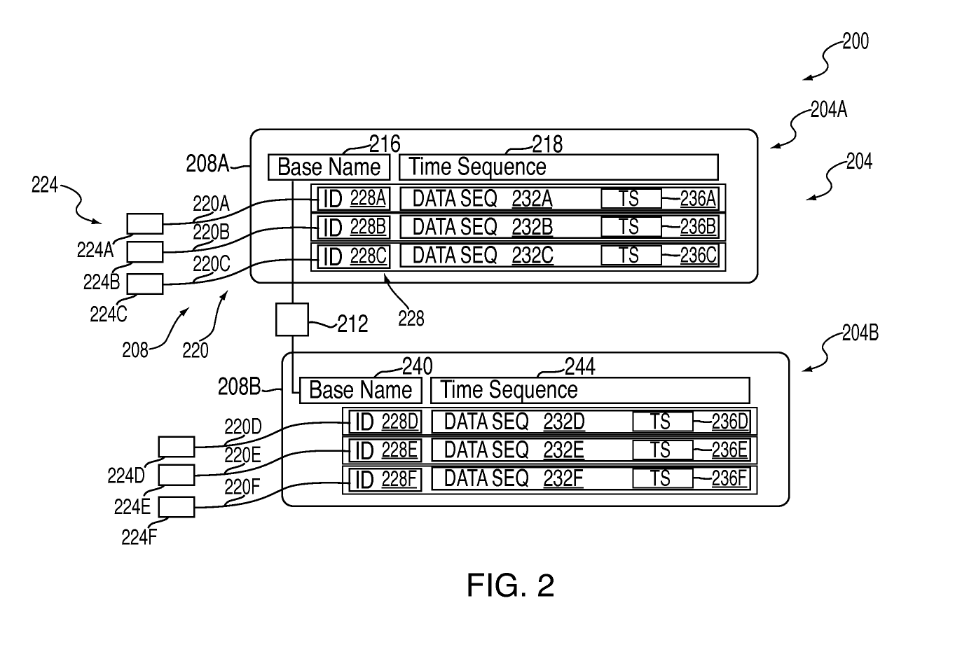

In general, each node 112 in network 104 (FIG. 1) possesses time-sequenced data recording and network connection features that allow for communicative interconnectivity among the nodes of the network. In one example, the time-sequenced data recording and network connection features include instructions that control the interactions between nodes 112 themselves and also between the nodes and patient sensors 108. In general, these instructions allow for the orderly input and release of information into and out of TSdBs 116. The instructions also allow requestor applications 148 to request single records, contiguous segments of time-sequenced records for display, analysis, and/or other uses, for example, to trigger certain actions, such as triggering a physician's office to contact a patient about adhering to a medical regimen. Since nodes 112 have common underlying data recording and network connection functionality, they can be considered self-similar with respect to storing and transmitting data. When combined with the topology shown in FIG. 1, each node 112 becomes a part of the distributed database structure with a simple, efficient addressing capability that allows access to local or remote data using a consistent, simple tiered naming convention (described in reference to FIG. 2).

The architecture of network 104 can take on any of many forms that facilitate communication between nodes 112, with the ultimate design of the network typically taking into consideration a number of factors. These factors include, but are not limited to, the number of nodes 112, the network bandwidth available, and the need for scalability of the network. In general, the architecture of network 104 should be highly scalable to allow for increased numbers of nodes 112 to be added to the network. Increased numbers of nodes 112 will increase the bandwidth necessary for network links 140.

The topology of a self-similar network of the present disclosure, such as network 100 of FIG. 1, can be designed with hierarchical levels and with restrictions on data transfer between levels. For instance, the network at issue may be configured such that each child node has only one parent node, while a parent node may have an unlimited number of child nodes. This is generally illustrated by the topology of network 104. The network may also, or alternatively, be configured with other restrictions. For example, the parent-child topology just mentioned may have an additional restriction that requires that record transfer can occur only from a child node to a parent node. This architecture results in a distributed hierarchy with increased verticality, which allows for lower network bandwidth requirements as the number, N, of nodes 112 increases. For instance, network 104, as shown in FIG. 1, has twenty nodes 112 and nineteen network connections 140. An increase in the number, N, of nodes 112 in network 104 results in an increase in the number of connections equal to N−1. Thus, there is a one-to-one increase in the number of connections with each additional node, which makes scalability of network 104 more manageable.

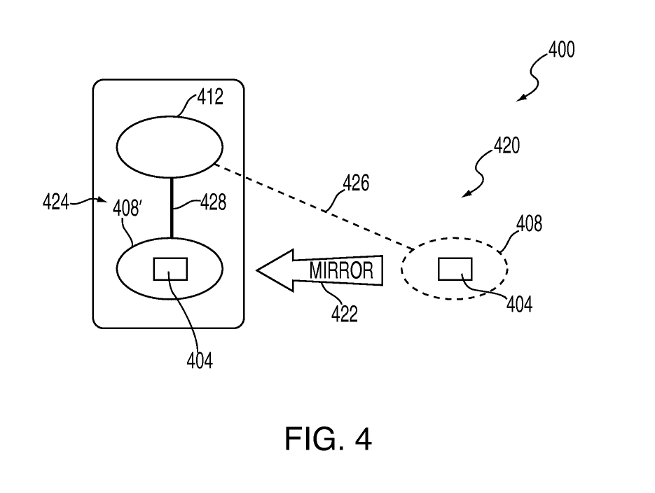

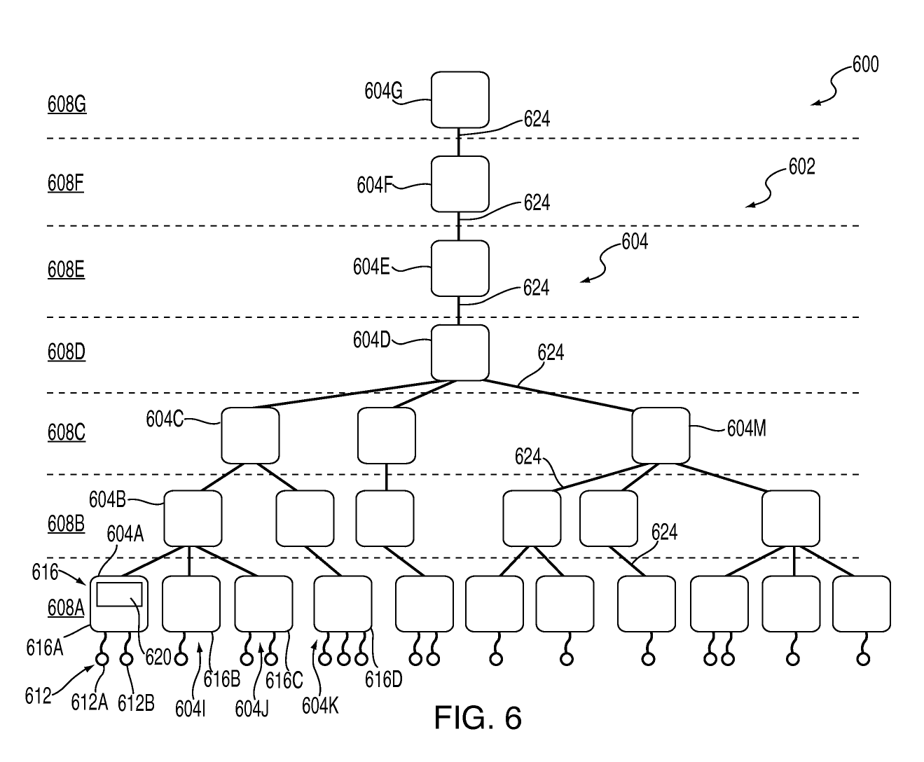

While in certain embodiments communication can be unrestricted between the nodes of the network, more typically communication between parent nodes and child nodes is limited. For example, while requests for information or records can be generated from any node within the network, the transmission of the information or records will only occur from a child node to a parent node. This configuration necessitates that an authorized party be given authorization to access information at a parent node. More detail regarding record movement and access of information and records is discussed in connection with FIGS. 4 and 6 below.

Alternatively, another possible architecture of a self-similar network that could be used for a medical communication system of the present disclosure is a “flat” architecture (not shown) in which each node has a direct connection to all the other nodes in the system. In order to accommodate an increase in the number of nodes, the number of network connections would need to grow geometrically with the number of nodes (i.e., C=N*(N−1), where C is the number of connections and N is the number of nodes). Thus, a flat architecture with one hundred nodes would have to have ninety-nine hundred connections, while a system with one thousand nodes would have nine-hundred ninety-nine thousand connections, and so forth. As evident, the number of connections, C, increases by a factor of over one hundred with each ten fold increase in the number of nodes, N, which may make the scalability of a flat network challenging when large numbers of nodes are connected together.

FIG. 2 shows a self-similar nodal system 200 that includes two nodes 204A-B, each including a corresponding TSdB 208A-B, that are hierarchically connected together via a network connection 212. As those skilled in the art will readily appreciate, nodes 204A-B could be implemented as any parent-node/child-node pair within a self-similar network of a medical communication system of the present disclosure, such as, for example, within nodal network 104 of FIG. 1. TSdB 208A includes a database name 216 and a time sequence 218. Database name 216 is an identifier for TSdB 208A that uniquely identifies TSdB 208A among the plurality of TSdBs that make up the self-similar nodal network of which TSdB 208A is a part, such as network 104 (FIG. 1). Time sequence 218 allows for the sequential organization of patient sensor data streams received directly from zero or more patient sensors associated with node 204A itself, in this example data streams 220A-C from patient sensors 224A-C, and/or received indirectly from, or via, another node, such as data streams 220D-F received from patient sensors 224D-F via node 204B.

Each patient sensor data stream 220A-C has a corresponding unique identifier 228A-C and contains a corresponding data sequence 232A-C. Each data sequence 232A-C is associated with a respective time-stamp 236A-C. The data arriving in each data sensor data stream 220A-C is synchronized with time sequence 218. The synchronization of sensor data from streams 220A-C with time sequence 218 allows for the identification of an instance of sensor data from the data streams by the combination of database name 216, the respective unique identifier(s), for example, any one or more of unique identifiers 228A-C, and a time on time sequence 218. Multiple instances recorded by one or more patient sensors 224 can also be identified by the combination of database name 216, the respective unique identifier(s), and a range of time or multiple ranges on time sequence 218.

Typically, TSdB 208B has the same structure as TSdB 208A, but has a different database name 240 and may have a different time sequence 244 than time sequence 218 of TSdB 208A. TSdB 208B may also be associated with zero or more patient sensor data streams, such as data streams 220D-F corresponding to patient sensors 224D-F, respectively. Each patient sensor data stream 220D-F has a corresponding unique identifier 228D-F and is associated with a corresponding data sequence 232D-F and a respective time-stamp 236D-F. Data from each patient sensor data stream 220D-F is synchronized with time sequence 244. The access to any one or more data sequences 232D-F within TSdB 208B through TSdB 208A via network connection 212 allows for the identification of one instance of sensor data from sensor data streams 220D-F by the combination of database name 216, database name 240, one or more of respective unique identifiers 228D-F, and a time on time sequence 244. Multiple instances recorded by one or more patient sensors 220 can also be identified by the combination of database name 216, database name 240, the respective unique identifier(s), and a range of time or multiple ranges on time sequence 244.

In an example wherein data in TSdB 208B is transmitted from node 204B to node 204A, time sequence 244 of TSdB 208B can be synchronized with time sequence 218 of TSdB 208A such that there is a common time sequence for the newly received data and the data already residing in TSdB 208A. In general, a common time sequence is a time sequence that results from interweaving data sequences from two or more TSdBs, such as TSdB 208A and TSdB 208B. For instance, if an authorized party desired data from both data sequence 232A and data sequence 232D, the organization of the two data sequences is ideally in a time sequential manner (i.e., a common time sequence). In this example, a common time sequence can be equal to time sequence 218 or time sequence 244, or to another time sequence such as a real time time-of-day clock.

Additional TSdBs can be added via additional nodes, such as nodes similar to or the same as nodes 112 (FIG. 1), to form a suitably deep and wide hierarchical network. This ability to connect multiple TSdBs via the hierarchical nodal structure of a self-similar network of the present disclosure, such as network 104, enables a powerful, efficient means to address and access data collected by a large number of sensors.

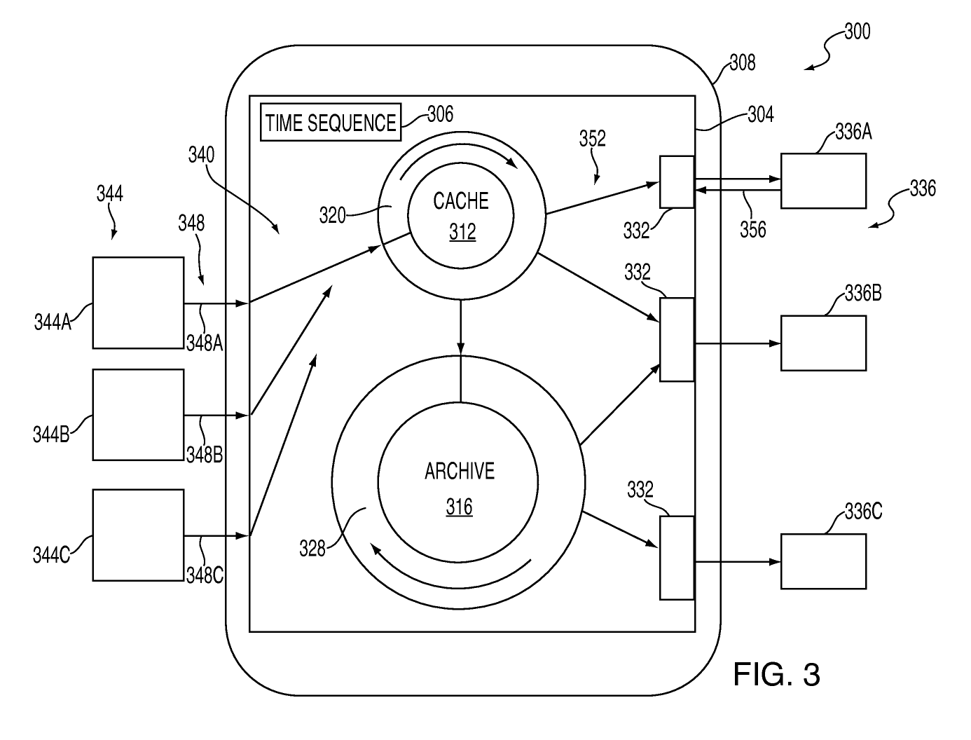

FIG. 3 is directed to an exemplary node 300 that could be used as a node in a self-similar nodal network of a medical communications system of the present disclosure, such as any one of nodes 112 of FIG. 1 and nodes 204A-B of FIG. 2. Node 300 includes a TSdB 304 with a time sequence 306. TSdB 304 resides in a memory 308, which in this example includes a cache memory 312 and an archive memory 316. The use of cache memory 312 allows for gapless access to a specified amount of most-recent information, while archive memory 316 retains older records. Cache memory 312 includes a cache structure 320 that allows for the organization of sensor data received from one or more patient sensor data streams. Similarly, archive memory 316 includes an archive structure 328 that allows for the organization of data received from cache memory 312. In this example, node 300 also includes authorization units 332 for ensuring that data requests from corresponding respective requesting entities 336A-C are indeed authorized. When any of requesting entities 336A-C makes a request, the corresponding authorization unit(s) 332 authenticates the request before node 300 releases the requested data from cache memory 312 and/or archive memory 316 to the requesting entity(ies). As those skilled in the art will readily appreciate, each requesting entity 336A-C can be any one of several entities, such as a requestor application (e.g., any of requestor applications 148 of FIG. 1) and another node, such as any of the parent nodes 112 of FIG. 1 and either of nodes 204A-B of FIG. 2.

In this example, node 300, and consequently, TSdB 304, receive information 340 from three data sources 344A-C, which can include, for example, one or more patient sensors (such as patient sensors 108 of FIG. 1 and sensors 224A-F of FIG. 2), one or more WPDRs (such as WPDRs 144 of FIG. 1), and/or one or more other nodes (such as nodes 104 of FIG. 1 and nodes 204A-B of FIG. 2), via a corresponding respective sensor data streams 348A-C. As discussed above relative to FIG. 2, information 340 includes unique identifiers for the various data streams 348A-C and data sequences and corresponding time stamps associated with the data streams. Upon receipt of information 340 or at a time thereafter, TSdB 304 places the information into cache structure 320.

Generally, TSdB 304 organizes information 340 into cache structure 320 according to the process described above with respect to FIG. 2. For example, when multiple sources 344 are in communication with TSdB 304, cache structure 320 can be configured to organize information 340 received from each of sensor data streams 348A-C by its unique identifier (see, e.g., unique identifiers 228A-F of FIG. 2) and time stamp (see, e.g., time stamps 236A-F) associated with the information, according to time sequence 306. This organization allows for the sequential organization of information 340 according to each unique identifier and time sequence 306. Alternatively, TSdB 304 may apply a time stamp upon receiving information 340 and place the information at a point in cache structure 320 so that it is the most-recently added.

TSdB 304 can be configured to operate in a recording mode in which information 340 placed in cache structure 320 is eventually placed into archive memory 316, which contains an archive structure 328 for long-term storage. For instance, when or if the configured size of cache structure 320 is reached, new information 340 replaces the oldest information in cache memory 312, i.e., the oldest information is moved to archive memory 316 (or discarded if no archive memory 316 exists) and replaced with the new information. Information 340 in archive memory 316 can be organized in the same manner as cache memory 312 (i.e., via, for instance, unique identifier 228A and time stamp 236A (FIG. 2)). Thus, when new information 340 is added to archive structure 328, if the configured size of archive structure is reached, the oldest information will be discarded to make room for new information such that a continuous time sequence of information is maintained. The storage of information 340 into archive structure 328 is flexible, in that the information need not be written to the archive structure immediately, but instead may be archived later depending on the record handling demands of TSdB 304.

Typically, information 340 in cache memory 312 and archive memory 316 can be accessed at any time until the information is overwritten by newer information and cache structure 320 and archive structure 328 are random-access. It is the combination of overwriting the oldest information 340 and random access that defines cache structure 320 and archive structure 328 that TSdB 304 creates when it stores the information in cache memory 312 and archive memory 316, respectively, and which distinguishes cache structure 320 and archive structure 328 from other storing methodologies, such as a queue or FIFO.

As mentioned above, a function of TSdB 304 is to provide information 340 to requesting entities 336A-C. TSdB 304 provides requesting entities 336A-C with access to data in cache memory 312 and/or archive memory 316, depending on where the data resides within node 300. In this regard, exemplary TSdB 304 performs two additional important functions: (i) the TSdB allows for requests for data from multiple requesting entities 336, and (ii) the TSdB merges information 340 at authorization unit 332 from multiple areas of cache structure 320, archive structure 328, or a combination of both, into an output stream 352 before forwarding the information to the relevant one(s) of requesting entities 336A-C. Thus, TSdB 304 provides each requesting entity 336 with a single interface to all of the information made available on the network for which that requesting entity has proper authorization.

Given the sensitivity of medical records, it is important that any requesting entity 336A-C have the proper authorization in order to access information 340. Authorization may be granted, for example, by the sending of an authorization request 356 to the TSdB containing the information, such as TSdB 304. For example, requesting entity 336A may send authorization request 356 to TSdB 304. If TSdB 304 has the appropriate information 340 and authorization request 356 contains the appropriate information, for example, a username and password, the TSdB can extract the information from the appropriate location, (i.e., cache structure 320, archive structure 328, or both) and send the information to requesting entity 336A.

TSdB 304 can be configured to implement a read-lock on information 340 being read by any of requesting entities 336A-C from cache structure 320 and/or archive structure 328 so that the TSdB does not write over the information while it is being read. TSdB 304 will typically also lock information 340 it is writing (i.e., “write lock”) to cache structure 320 and/or archive structure 328. To achieve this locking, TSdB 304 may maintain a buffer lock table (not shown) that identifies which region(s) of cache structure 320 and/or archive structure 328 are locked, whether one or more sensor data streams 348A-C have been received, whether a write lock is active and the number of read locks. While FIG. 3 illustrates one exemplary embodiment of a node suitable for implementing in a self-similar network made in accordance with the present disclosure, those skilled in the art will appreciate that the nodes in such a network can be configured in any of a variety of ways different from node 300 of FIG. 3.

FIG. 4 illustrates a data mirroring technique 400 that can be implemented in a self-similar data network of the present disclosure, such as network 104 of FIG. 1. Data mirroring technique 400 can be implemented to create a backup of information 404 residing on a node, such as node 408 in this example, or when there is intermittent connectivity between nodes, for instance, between a child node and a parent node. Regarding the latter, in FIG. 4, node 408 could be the child node of parent node 412. In another example, both nodes 408, 412 could be siblings to one another. In the case of intermittent network connectivity, such as over a wide area network connection (WAN) 416, child node 408 may mirror all or a portion of its information 340 to a mirrored child node 408′ where it can be more reliably accessed by parent node 412. Thus, information 404 that is available from a normal pathway 420, i.e., child node 408 to parent node 412, are also available via a mirrored pathway 424, i.e., child node 408′ to parent node 412. Mirrored pathway 424 may be more reliable over a local area network (LAN) 428 as compared to the intermittent connection over WAN 416.

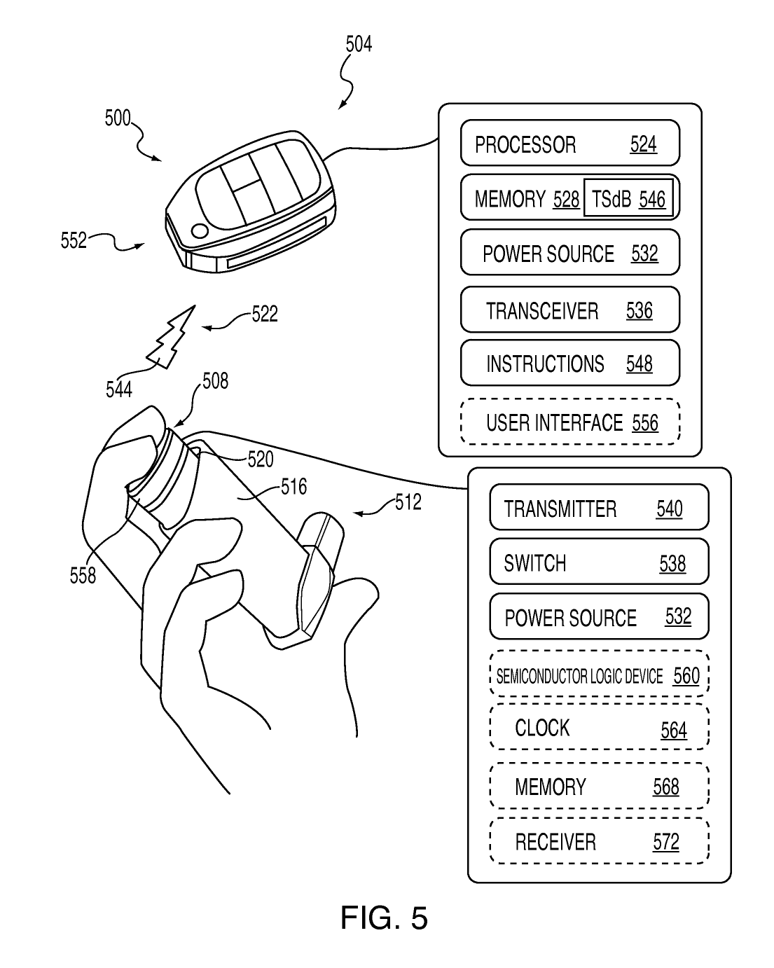

FIG. 5 illustrates an exemplary personal medical adherence (PMA) system 500 suitable for use in a medical communications system, such as system 100 of FIG. 1. In this example, PMA system 500 includes a WPDR 504 in communication with a patient sensor, which in this instance is an adherence sensor 508 that senses when a user actuates a metered-dose inhaler 512 so as to dispense a particular medicament that is part of the user's medical regimen. As those skilled in the art will appreciate, inhaler 512 includes a dispensing device 516 and a medicament canister 520 that engages the dispensing device. In this example, adherence sensor 508 is a pressure sensor located on top of medicament canister 520. Adherence sensor 508 is triggered whenever a user presses the sensor/medicament canister 520 combination into dispensing device 516. Assuming WPDR 504 is within range of adherence sensor 508, the sensor wirelessly transmits information regarding the actuation of inhaler 512, such as an indication of the actuation and/or duration of the actuation, etc., to the WPDR either simultaneously with the depression of the sensor/medicament canister 520 combination or at a time thereafter. Adherence sensor 508 can be linked, for example, to WPDR 504 via a wireless personal area network 522 capable of exchanging information over short distances from fixed and mobile devices, creating personal area networks (PANs).

Both WPDR 504 and adherence sensor 508 typically have minimal feature sets that are sufficient to carry out the necessary tasks of each device. Thus, as shown in FIG. 5, WPDR 504 includes a processor 524, a memory 528, a power source 532, and a transceiver 536, while adherence sensor 508 has a switch 538 and a transmitter 540. As would be readily apparent to those skilled in the art, in alternative embodiments WPDR 504 and adherence sensor 508 may have additional features and attributes such as user interfaces, additional software, etc.

WDPR 504 is configured to collect, store, and release information 544 from adherence sensor 508 via a TSdB, such as TSdB 546. TSdB 546 resides in memory 528, which can be configured to include a cache memory, such as cache memory 312, and an archive memory, such as archive memory 316, and to perform the tasks, aspects, and embodiments described herein. With this configuration, WDPR 504 can be a node in a medical communication system of the present disclosure and TSdB 546 can operate as described relative to FIG. 3.

The passive aggregation of information 544 by WPDR 504 from adherence sensor 508 allows for reduced interaction between the WPDR and the user. This is ideal for medical compliance purposes because a user does not need to perform additional steps aside from taking their medication in order for WPDR 504 to record information 544. In addition, WPDR 504 is “wearable” in the sense that it is relatively small and can conveniently fit in the pocket of a user, be clipped to a belt, worn on a band (e.g., a wristband), or otherwise worn by the user. For example, in an exemplary embodiment of WPDR 504, instructions 548 are uploaded to a preexisting device having preexisting features and functionality, such as device 552 shown in FIG. 5, which may be a key fob, phone, PDA, etc. Instructions 548 configure device 552 to perform the tasks, aspects, and embodiments described herein. A PAN can be created between device 552 and adherence sensor 508 using Bluetooth®, frequency modulation (FM), or other wireless protocol. For instance, if device 552 is a smartphone, (i.e., a phone with enhanced with personal-computer-like capabilities, such as email) adherence sensor 508 could pair with the smartphone and communicate via, for instance, a Bluetooth®, Wi-Fi®, FM connection, or others known in the art. In some embodiments, a repeater module (not shown) may be used to coordinate between adherence sensor 508 and device 552. The repeater module can be configured to convert, for instance, an FM signal received from adherence sensor 508 to a Bluetooth® signal receivable by device 552. The repeater module may also include any features necessary, such as a memory and microprocessor, to temporarily hold and retransmit information to device 552 if the device happens to be out of range. As those skilled in the art would likely appreciate, other coupling mechanisms and connectivity intermediaries are available that would connect device 552 and adherence sensor 508.

Processor 524 controls the operation of WPDR 504 and transceiver 536 receives information 544 from adherence sensor 508 and sends information to suitable requestors (not shown). Those skilled in the art will understand that processor 524 and transceiver 536 can be of a conventional design and, therefore, need not be described in detail herein. Example processors include, but are not limited to, a microcontroller, embedded controller, CPU, digital signal processor, and any combinations thereof. WPDR 504 may include one or more processors that provide the WPDR with additional processing functionality, if desired. In an alternative embodiment, processor 524 may be combined in a single integrated circuit element with transceiver 536.

Power source 532 provides the energy necessary to operate WPDR 504. In one example, power source 532 is a disposable battery; however, as would be understood by those skilled in the art, power source 532 can be a rechargeable battery, a hard wire connection to an electricity source, a photovoltaic cell, a scavenged power source, charged capacitors, etc.

Optionally, WPDR 504 may include a user interface 556, such as a keyboard, touch-screen, voice-command functions, etc., and may include other software packages for increased functionality if desired by a user.

When adherence sensor 508 is used in combination with inhaler 512, the adherence sensor can be attached to medicament canister 520 in any suitable manner, for example, via adhesives or a snap-in/snap-on design. In order to preserve its original FDA-approved medication delivery performance, adherence sensor 508 should not interfere with or alter the inhaler 512. In this regard, adherence sensor 508 can have a housing 558 that has a size and configuration that does not extend beyond the periphery of the end surface of medicament canister 520. In certain embodiments, adherence sensor 520 may be disposable and include a protective cap (not shown) to prevent unintentional activation.

While in the example just described adherence sensor 508 is a simple switch for determining when a user has dispensed an aerosol medicament from inhaler 512, other types of patient sensors compatible with a medical communications system of the present disclosure can be configured to be placed on other medical dispensers or devices, at various positions on a users body, and/or in the environment of the user in order to collect data on various activities of a user. For example, adherence sensor 508 may also be mounted in or on any number of medicament or medication, which may be any kind of medicine, prescription or otherwise and may be in any form, such as, pills, salves, creams, powders, ointments, capsules, injectable medications, drops, vitamins and suppositories.

Adherence sensor 508 may also be a physiological sensor configured to monitor a physiological condition of a person, including, but not limited to, body temperature, blood pressure, blood sugar levels, and heart rate, by placing the physiological sensor at the medically appropriate locations on the user's body. The information received from a physiological sensor can be information such as, but not limited to, breathing information that may help physicians diagnose the efficacy of a certain treatment regimen. Further information may be generated with environmental sensors that monitor conditions around the user or on articles with which the user interacts (such as a weight scale). Environmental sensors may be stand-alone sensors that reside around a patient, or may be integrated with another sensor, such as with adherence sensor 508. Adherence sensors 508 may also include the ability to give global positioning coordinates. As will be apparent to a person skilled in the art, if more than one adherence sensor 508 is used, the sensors need not all be of the same kind.

In an exemplary embodiment of adherence sensor 508, the adherence sensor can include a semiconductor logic device 560, for example, a microcontroller, microprocessor, or microserver, and also a clock 564, and a memory 568. In this embodiment, adherence sensor 508 can be configured to retransmit information 544 when it is detected that WPDR 504 is out of range, thus alleviating concerns about possible losses of information because of an out of range WPDR.

In another embodiment, adherence sensor 508 may additionally include a receiver 572 (or alternatively, transmitter 540 may be combined with receiver 572 as with transceiver 536). If WPDR 504 is within range of adherence sensor 508, semiconductor logic device 560 transmits information 544, and any additional information stored in memory 564, to the WDPR. Then, semiconductor logic device 560 can confirm that WPDR 504 received information 544 and, if so, delete the information stored in memory 564.

In yet another embodiment, adherence sensor 508 periodically “polls” for other nearby adherence sensors that belong to the same patient (for example, a patient may have multiple inhalers, each with the adherence sensor described previously, or a patient may have any combination of sensors, i.e., physiological, environmental, etc., described previously). Upon detection of another adherence sensor 508, both adherence sensors exchange all stored information 544, thus providing each adherence sensor 508 with a complete set of information. Then, when one adherence sensor 508 is subsequently brought within range of WPDR 504, all information 544 available on adherence sensor 508 is transmitted to the WPDR. Information conveyed by the transmission to WPDR 544 could also be stored so that subsequent inter-attachment communications, i.e., communications between the two previously inter-connected adherence sensors 508, would result in the deletion of already-transmitted information 544.

The aforementioned adherence sensors 508, when used in combination with one another and with a nodal network, such as network 104, can give interested entities a wide variety of information. For instance, a patient's use of an inhaler (recorded by adherence sensor) and a patient's breathing patterns (recorded by physiological sensor) may be transmitted via transmitter 540 to the WPDR 504 (in information 544), which relays the information and its location, via, for instance, GPS coordinates, to the network, such as network 104 (FIG. 1) when requested. Pollen data from a local environmental sensor may then be interwoven with the other collected information 544, using the time stamp associated with the information, so that interested parties may analyze local pollen counts from multiple WPDRs by region and time period. Thus, a doctor for a patient with asthma can monitor the patient's use of an inhaler, the patient's breathing habits before and after the use of the inhaler, the pollen count around the patient before the time of use of the inhaler, and where the patient was at the time of use. This information can help the doctor determine the appropriate treatment regimen for the patient.

As those skilled in the art will appreciate, switch 538 may be any one of many switches known in the art (such as mechanical, piezoelectric, electromechanical, or electronic) that are capable of monitoring the occurrence of an event or action of the user, typically related to acute changes in the switches. Switch 538 may be a dumb switch that senses at least one parameter and communicates an indication of the sensed parameter to WPDR 504, or an intelligent switch capable of some information processing. Switch 538 may be constructed out of sensors known in the art such as an accelerometer, pressure sensor, heat sensor, proximity sensor, contact sensor, strain gage, or most any other type of commercially available sensor, as well as sensors specially configured to operate within PMA system 500. As switch 538 can take on many forms known in the art, it is also understood that information 544 may contain additional information that may be provided by the switch in addition to the identifier associated with the patient sensor, unique identifier, such as unique identifier 228A (FIG. 2), and the time stamp relating to the occurrence of the event or action of the user, such as time stamp 236A (FIG. 2). This additional information 544 may include global positioning coordinates, pollen counts, temperature, barometric pressure, wind speed, or physiological characteristics (described above).

Typically, transmitter 540 is in electronic communication with switch 538 such that when the switch has been activated, transmitter 540 sends information 544 to WPDR 504. Alternatively, transmitter 540, rather than sending the information immediately upon the information being sensed by switch 538, may queue up and send at a later time or resend the information repeatedly until receipt of the information. As would be readily apparent to those skilled in the art, transmitter 540 may be any electronic device, e.g., radio (frequency modulated, amplitude modulated, etc.), optical, magnetic, hard-wired, etc., that generates and amplifies a carrier wave, modulates it with a meaningful signal and radiates the resulting signal. Alternative techniques and methodologies for facilitating information transfer between WPDR 504 and adherence sensor 508 are known in the art.

Communication protocols include any low power wireless communication protocol in the radio, microwave, or infrared frequency that is the same as or similar to, but not limited to, Bluetooth®, IEEE 802.11 (Wi-Fi®), IEEE 802.15.4-2003(Zigbee), FM, infrared, irDA, UWB, and Zwave. Data and authentication information are transmitted according to the standards of the associated communication protocol.

In some circumstances, adherence sensor 508 may not be in reliable radio communication range of WPDR 504, the adherence sensor may periodically transmit the most recent information 544, each with a time stamp relative to the current time. Adherence sensor 508, may include, but does not necessarily require, a real-time clock (not shown) synchronized to the time-of-day, as the associated WPDR 504 can derive actual event times given the relative times and its own time-of-day clock. To carry out either of these aforementioned alternatives, adherence sensor 508 can maintain a short event-buffer and a non-synchronized internal clock for the relative time stamps. Alternatively, adherence sensor 508 may transmit its unique identifier, such as unique identifier 228A (FIG. 2), and/or other information or data, via its radio transmitter to WPDR 504 which may record the time-of-arrival of the associated event using its own time-of-day clock.

FIG. 6 shows a medical communications system 600 with a self-similar network 602 that includes a plurality of nodes 604 at a plurality of levels 608A-G. In this example, ones of patient sensors 612 are linked to respective ones of WPDRs 616 as depicted in FIG. 6. Each WPDR 616 stores information 620 from each patient sensor 612 that is linked to that WPDR (e.g., WPDR 616A receives information from two patient sensors 612A-B), for example, in the manner described above relative to FIG. 5. Information 620 from patient sensors 612 are stored initially in TSdBs (not shown, but each can be like TSdB 304 of FIG. 3) residing in corresponding respective ones of WPDRs 616.

Other levels of exemplary network 600 are as follows: at level 608B, patients' personal computers; at level 608C, physicians; at level 608D, a hospital with which the physicians at level 608C are affiliated; at level 608E, a state health department of the state in which the patients live; at 608F, a federal health department; and, at 608G, the World Health Organization (WHO). Although nodes 604 at levels 608 D-F are shown as singular nodes for convenience, it should be understood that more nodes would typically be interconnected at each of these levels. For instance, level 608F, which is the federal, or country, level, could have multiple nodes corresponding to multiple participating countries that report to the WHO. Similarly, level 608E, the state level, could have nodes corresponding to all state health departments of all U.S. states/territories. Levels 616A-D are similarly shown truncated for convenience.

Network 600 allows for a highly flexible and secure approach to managing information 620. For instance, network 600 can be configured such that each of the entities (i.e., patients, physicians, hospitals, state health departments, etc.) residing on levels 608B to 608G can have different needs for information 620 and can have different access to the information at lower-level nodes. For example, if the WHO at node 608G would like to have access to information 620 on WPDR 616A at node 604A, the WHO would send a request through node 604F, node 604E, node 604D, node 604C, node 604B, and finally to node 604A, via network connections 624. In one example, each node 604 along a requested path includes an authorization unit (not shown, but such as authorization unit 332 in FIG. 3) that authorizes requests for information along various chains of nodes to foster data security. If the WHO provided the proper credentials to the authorization unit of each node 604 along the request path, all or a portion of information 620 stored on WPDR 616A would be sent along the same path to node 604G, (i.e., from node 604B to node 604C to node 604D to node 604E to node 604F and finally to node 604G), depending on the amount of information requested.

In some circumstances it may not be necessary for the WHO to send a request to WPDR 616A to obtain information 620. This may occur, for example, if one of the intervening nodes, such as node 604D, has already requested and obtained the information from WPDR 616A. In that case, the WHO only has to send a request from node 604G to node 604F to node 604E to node 604D.

An alternative request scenario could occur if the request comes from a node 604 that is not hierarchically connected above the source of information 620. For example, if a physician located at node 604H desired to have information 620 from 616A, the physician would be able to send a request from node 604H to node 604D to node 604C to node 604B to WPDR 616A. Typically, even if WPDR 616A approved of sending information 620 to node 604H, the information could only be transmitted as far as node 604D. This limitation on the transfer of information on network 602 reduces the number of network connections required in network 602 and thus improve the scalability of network 600. In another embodiment, information 620 may be transmitted to the physician at node 604H with the acknowledgement that his architecture may limit future expansion of network 600.

Each node, for example, node 604C, node 604D, etc., in network 600 can contain information 620, or obtain the information, from either an external patient sensor 612 or from another connected node 604 so long as the node has appropriate authorization. Certain ones of parent nodes 604 in network 600 may serve to collect information 620 from a relatively larger number of WPDRs 616, for instance, node 604C may collect information from WPDRs 616A-D (nodes 604A, 604I, 604J, and 604K). As mentioned previously, typically, node 604C would need to have access to each WPDR 616, or said another way, the nodes access could be restricted by the user of any one of the WPDRs. For example, the user of WPDR 616A may allow for transfer of information 620 to a computer at node 604B, but restrict access of his/her information beyond this node. However, user of WPDR 616B may allow for transfer of information 620 to the computer at 604B and then allow for his/her doctor to access the information on the computer at node 604C.

This situation may occur when, for instance, WPDR 616A is used by a child and WPDR 616B is used by a caretaker (e.g., a parent). The caretaker may make the decision that while they would like to monitor the child's activities on a computer at node 604B, there is no need to allow others access to information 620 of the child.

The structure of network 602 allows for many requestors to access information crucial to the efficient management of health care services. For instance, the WHO may desire to investigate the usage of certain drugs and the reduction in disease in a certain region of the world. In this hypothetical example, the WHO may retrieve drug usage, i.e., information 620, from a plurality of WPDRs 616 that are located in the region of interest (identified by global positioning coordinates). The WHO could then compare the actual usage of the drug in the region to the decreased incidence of disease (which may come from doctors, hospitals, state agencies, etc. either on network 602 or via other databases). This information could be used to evaluate whether inconsistent use of the drug is causing the incidence of disease to be higher than expected, rather than the inefficacy of the drug itself. The WHO may then be able to take this information to issue guidance for better treatment options/protocols.

In another example, groups of users could be put on trials of medications, the usage of which needed to be closely monitored. Again, system 100 would provide the ability to carefully manage clinical trials and the ability for the trial managers to identify problems with the trial procedures or the drug. In another alternative, an interested entity, such as the state health agency, may be able to monitor people's activities in locations that may have hazardous conditions. For example, the state may provide patient sensor 612A-B to the patient having WPDR 616A. Patient sensor 612A can be a physiological sensor that monitors pollutants in the body and patient sensor 612B can be a location sensor that gives the patient's global positioning coordinates. With this information, the state health agency can monitor increases in pollutants in a person when they are in the vicinity of certain locations. Alternatively or additionally, the state may be able to find out where hazardous sites are by monitoring increases in body pollutants and using the global positioning coordinates to locate the hazardous site. In yet another alternative, patient sensors can be environmental sensors that are widely distributed to users by an interested entity, such as the state health agency or other organization. The information received from the environmental sensors may be used to create microclimate maps that could be available for users to identify pollution zones or for the analysis of weather patterns.

As would be evident to a person skilled in the art, system 600 provides extensive monitoring and reporting capabilities and has a highly expandable network structure that would allow for significant data collection without the need for a large storage database. System 600 also provides an inherent level of security as sensitive information is controlled by the collector of the data and the information is not stored in a single or even several large databases. Thus, the structure of system 600 guards against the possible massive undesired dissemination of sensitive information.

It is to be noted that one or more of the aspects and embodiments described herein may be conveniently implemented using a machine (e.g., a computing device) programmed and communicating with other specialized components according to the teachings of the present specification, as will be apparent to those of ordinary skill in the art. Appropriate software coding can readily be prepared by persons skilled in the software art based on the teachings of the present disclosure, as will be apparent to those of ordinary skill.

Such software may be a computer program product that employs a machine-readable medium. A machine-readable medium may be any medium that is capable of storing (i.e., a storage medium) and/or encoding a sequence of instructions (e.g., a signal) for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as the possibility of including a collection of physically separate media, such as, for example, a collection of compact disks or one or more hard disk drives in combination with a computer memory.

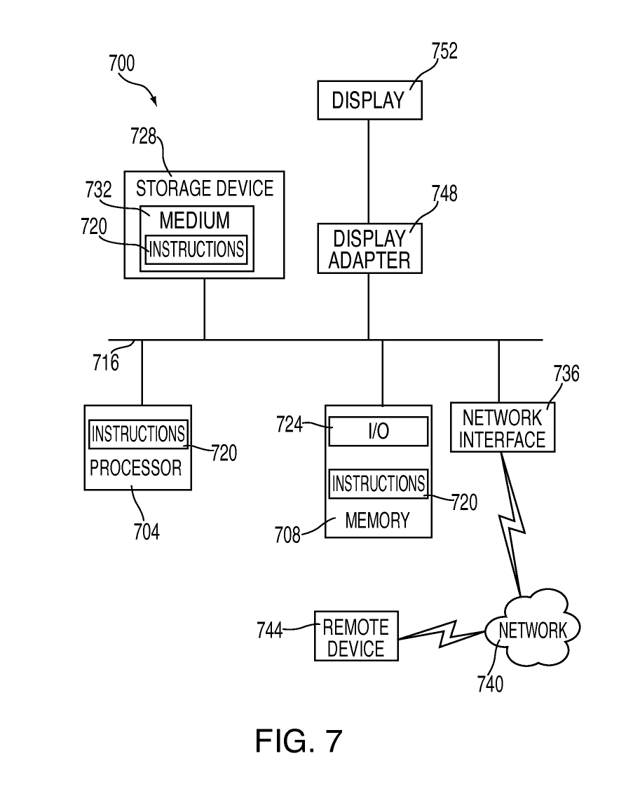

FIG. 7 shows a diagrammatic representation of one implementation of a machine/computing device 700 that may be used in a self-similar nodal network, such as network 104, within which a set of instructions for causing the node to perform any one or more of the aspects and/or methodologies of the present disclosure may be executed. Device 700 includes a processor 704, such as processor 524 and a memory 708, such as memory 528, that communicate with each other, and with other components, via a bus 716. Processor may also include (e.g., stored on one or more machine-readable media) instructions (e.g., software) 720 embodying any one or more of the aspects and/or methodologies of the present disclosure. Bus 716 may include any of several types of communication structures including, but not limited to, a memory bus, a memory controller, a peripheral bus, a local bus, and any combinations thereof, using any of a variety of architectures.

Memory 708 may include various components (e.g., machine readable media) including, but not limited to, a random access memory component (e.g., a static RAM, or “SRAM”, a dynamic RAM, or “DRAM”, etc.), a read-only component, and any combinations thereof. In one example, a basic input/output system 724 (BIOS), including basic routines that help to transfer information between elements within device 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Device 700 may also include a storage device 728. Examples of a storage device (e.g., storage device 728) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 728 may be connected to bus 716 by an appropriate interface (not shown). Example interfaces include, but are not limited to, SCSI, advanced technology attachment (ATA), serial ATA, universal serial bus (USB), IEEE 1395 (FIREWIRE), and any combinations thereof. In one example, storage device 728 may be removably interfaced with device 700 (e.g., via an external port connector (not shown)). Particularly, storage device 728 and an associated machine-readable medium 732 may provide nonvolatile and/or volatile storage of machine-readable instructions, data structures, program modules, and/or other data for device 700. In one example, instructions 720 may reside, completely or partially, within machine-readable medium 732. In another example, instructions 720 may reside, completely or partially, within processor 704.

Device 700 may also include a connection to another device 700 in the network. Another device 700 may be interfaced to bus 716 via any of a variety of interfaces (not shown) including, but not limited to, a serial interface, a parallel interface, a game port, a USB interface, a FIREWIRE interface, a direct connection to bus 716, and any combinations thereof. Alternatively, in one example, a user of device 700 may enter commands and/or other information into device 700 via an input device (not shown). Examples of an input device include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof.

A user may also input commands and/or other information to device 700 via storage device 728 (e.g., a removable disk drive, a flash drive, etc.) and/or a network interface device 736. A network interface device, such as network interface device 736 may be utilized for connecting device 700 to one or more of a variety of networks, such as network 740, and one or more remote devices 744 connected thereto, such as adherence sensor 508. Examples of a network interface device include, but are not limited to, a network interface card, a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 740, may employ a wired and/or a wireless mode of communication. In general, any network topology may be used. Information (e.g., data, instructions 720, etc.) may be communicated to and/or from device 700 via network interface device 736.

Device 700 may further include a video display adapter 748 for communicating a displayable image to a display device 752. Examples of a display device 752 include, but are not limited to, a liquid crystal display (LCD), a cathode ray tube (CRT), a plasma display, and any combinations thereof.

In addition to display device 752, device 700 may include a connection to one or more other peripheral output devices including, but not limited to, an audio speaker, a printer, and any combinations thereof. Other peripheral output devices may be connected to bus 716 via a peripheral interface 756. Examples of a peripheral interface include, but are not limited to, a serial port, a USB connection, a FIREWIRE connection, a parallel connection, a wireless connection, and any combinations thereof.

A digitizer (not shown) and an accompanying pen/stylus, if needed, may be included in order to digitally capture freehand input. A pen digitizer may be separately configured or coextensive with a display area of display device 752. Accordingly, a digitizer may be integrated with display device 752, or may exist as a separate device overlaying or otherwise appended to display device 752.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A medical communications system, comprising:
a self-similar nodal network having a plurality of time-sequenced databases arranged in a hierarchical structure and communicatively interconnected with one another, said time-sequenced databases having information that is indexed by unique identifier and time, wherein said self-similar nodal network includes:
a plurality of patient sensors, wherein each of said plurality of patient sensors is configured for detecting an action by a corresponding object associated with that one of said patient sensors and for generating, in response to the detecting, a corresponding signal, wherein the corresponding signal contains a record that includes 1) a time of an occurrence of the action and 2) a unique identifier for the corresponding one of said plurality of patient sensors; and
a plurality of wearable personal data recorders, wherein each of said plurality of wearable personal data recorders includes a corresponding time-sequenced database of said plurality of time-sequenced databases and is configured to store the record in time sequence within said first time-sequenced database.

2. A system according to claim 1, wherein the record further includes data regarding the action that is indexed based on the time of the action and the unique identifier.

3. A system according to claim 1, wherein each of said plurality of wearable personal data recorders uses substantially identical logic for storing and transmitting the record.

4. A system according to claim 1, wherein at least one of said plurality of wearable personal data recorders transmits a first portion of said corresponding time-sequenced database that contains one or more occurrences of the action to another one of said plurality of wearable personal data recorders, wherein said another one of said plurality of wearable personal data recorders:
has a second portion of said corresponding time-sequenced database that contains one or more of the occurrences the action, and
interweaves said first portion into said second portion according to a common time sequence.

5. A system according to claim 1, wherein one or more of said plurality of patient sensors is configured to retransmit the record or a plurality of records.

6. A system according to claim 1, wherein one or more of said plurality of patient sensors is for an inhaler including a medicament canister with a first portion and a dispensing device surrounding the medicament canister, and wherein said patient sensor comprises:
a housing coupleable with the first portion of the medicament canister, said housing being sized and configured to avoid contact with the dispensing device during operation of the inhaler;
a switch associated with said housing, said switch being activated by physical pressure and without regard to whether or not medicine is exiting the medicament canister, wherein application of physical pressure to said switch generates the record; and
a transceiver for transmitting the record and for receiving a communication from a wearable personal data recorder or another of said plurality of patient sensors.

7. A system according to claim 5, wherein said one or more of said plurality of patient sensors includes a semiconductor logic device connected to said switch for creating and storing information regarding use of said sensor.

8. A method of monitoring an action of a user, the method comprising:
receiving a first signal that contains a first record including a time of a first occurrence initiated by a user and a unique identifier;
storing the first record in time sequence in a time-sequenced database of a wearable personal data recorder worn by the user, wherein the time of the occurrence and the unique identifier are indexed by the time of the occurrence and the unique identifier;
receiving a second signal that contains a second record including a time of a second occurrence initiated by a user and a unique identifier; and
organizing the first record and the second record according to a common time series.

9. A method according to claim 8, further comprising communicating one or both of the first and second records with a node in a self-similar nodal network, the self-similar nodal network having a plurality of interconnected time-sequenced databases arranged in a hierarchical structure, each of the plurality of interconnected time-sequenced databases having data that is indexed by unique identifier and time.

10. A method according to claim 8, wherein each of the first and second records further includes data regarding the action that is indexed based on the time of the occurrence and the unique identifier.

11. A method according to claim 8, wherein said organizing results in a combined occurrence database searchable by the time of the occurrence and the unique identifier.

12. A method according to claim 11, further comprising requesting a portion of the combined occurrence database.

13. A method according to claim 11, wherein each of the first and second records further includes data regarding the action and global positioning system coordinates corresponding to a global positioning system location of the user at the time of occurrence.

14. A method according to claim 13, wherein said organizing results in a combined occurrence database searchable by the time of the occurrence, the unique identifier, the data, and the global positioning system coordinates.

15. A method according to claim 14, further comprising requesting a portion of said combined occurrence database, wherein the portion is determined by a set of the global positioning system locations and a plurality of the time of the occurrence.

16. A method of retrieving a patient record collected from a wearable personal data recorder via a patient sensor, comprising:
communicatively connecting to a self-similar nodal network that includes a plurality of time-sequence database nodes, wherein the patient record is stored in the self-similar nodal network;
issuing a retrieve command for the patient record to the self-similar nodal data network so as to cause the self-similar nodal network to retrieve the patient record from among the plurality of time-sequence database nodes; and
retrieving the patient record via a nodal chain that includes at least three of the plurality of time-sequence database nodes.

17. A method according to claim 16, wherein the patient record includes a time of an occurrence and a unique identifier.

18. A method according to claim 17, wherein the patient record further includes a datum corresponding to the time of an occurrence.

19. A method according to claim 16, wherein said retrieving the patient record includes retrieving the patient record from more than one of the plurality of time-sequence database nodes.

20. A machine-readable storage medium containing machine-executable software instructions for performing a method of retrieving a patient record collected from a wearable personal record recorder via a patient sensor, said machine-executable software instructions comprising:
a first set of machine-executable instructions for connecting to a self-similar data nodal network that includes a plurality of time-sequence database nodes, wherein the patient record is stored in said self-similar nodal network;
a second set of machine-executable instructions for issuing a retrieve command for the patient record to the self-similar nodal network so as to cause the self-similar nodal network to retrieve the patient record from among the plurality of time-sequence database nodes; and
a third set of machine-executable instructions for retrieving the patient record via a nodal chain that includes at least three of the plurality of time-sequence database nodes.

21. A method according to claim 20, wherein the patient record includes a time of an occurrence and a unique identifier.

22. A method according to claim 21, wherein the patient record further includes a datum corresponding to the time of an occurrence.

23. A method according to claim 20, wherein said third set of machine-executable instructions includes machine-executable instructions for retrieving the patient data from more than one of the plurality of time-sequence database nodes.

24. A wearable personal data recorder for relaying patient sensor information, said wearable personal data recorder comprising:
a processor;
a memory in communication with said processor, said memory containing a time-sequence database and storing a set of instructions executable by said processor for making the wearable personal data recorder a node in a hierarchical self-similar nodal network; and
a transceiver in communication with said processor, said transceiver responsive to said set of instructions and said processor;
wherein said set of machine-readable instructions configures the wearable personal data recorder to:
receive a signal from the adherence sensor, wherein the signal includes a record;
synchronize the record with said time-sequence database; and
store the record in said memory.

25. A wearable personal data recorder according to claim 24, wherein said set of instructions further configures the wearable personal data recorder to:
receive a request for the record from a requestor node in the hierarchical self-similar nodal network;
determine, in response to the request, whether or not release of the record to the requestor node is authorized; and
if the release of the record is authorized, transmit the record to the requestor node.

26. A wearable personal data recorder according to claim 24, wherein the record includes a unique identifier and a time of occurrence of an action.

27. A method of distributing wearable personal data recorders for a hierarchical self-similar nodal network comprising:
distributing to a wireless device a set of instructions, wherein the set of instructions configure the wireless device to:
receive a record into a time-sequence database;
synchronize the record with the time-sequence database according to common time sequence;
receive a request for the record from a record requestor;
authorize the release of the record to the record requestor;
transmit the record from the wireless device to the record requestor; and
linking the wireless device to a patient sensor that is operatively coupled to a medical device and generates a signal in response to a user performing actions on the medical device, wherein the signal contains the record.

28. A method according to claim 27, wherein the hierarchical self-similar nodal network includes parent nodes and child nodes, wherein every parent node has one or more children nodes but every child node has only one parent node.

29. A method according to claim 27, wherein said distributing to a wireless device a set of instructions includes a set of instructions to further configure the wireless device to:
receive environmental signals from an environmental sensor that generates the environmental signals;
store in the time-sequence database, in response to the receipt of the environmental signals, environmental data carried on the environmental signals;
authorize requests for the environmental data made over the hierarchical self-similar nodal network; and
transmit, in response to an authorized request, the environmental data to the record requestor using the hierarchical self-similar nodal network.

30. A method according to claim 29, further comprising:
distributing wearable personal data recorders containing the set of instructions, wherein each of the wearable personal data recorders is configured as a self-similar node on the hierarchical self-similar nodal network so as to contain a time-sequence database.

31. A method according to claim 30, wherein said distributing the wearable personal data recorders includes distributing wearable personal data recorders that each include a global positioning system that generates global positioning coordinates of that wearable personal data recorder and that is further configured to store in the corresponding time-sequence database, in response to the receipt of the environmental signals, global positioning coordinates.

32. A method according to claim 30, wherein said distributing the wearable personal data recorders includes distributing wearable personal data recorders each further configured to store, in response to the receipt of the environmental signal, in the corresponding time-sequence database, environmental data.

33. A method, comprising:
implementing a medical regime adherence monitoring system for monitoring adherence of one or more people to corresponding respective medical regimes requiring that actions be taken by the one or more people, said implementing the medical regime adherence monitoring system including:
establishing a hierarchical self-similar nodal network of time-sequence databases; and
providing each person of the one or more people with a wearable personal data recorder configured:
as a self-similar node on the hierarchical self-similar nodal network so as to contain a corresponding time-sequence database of the time-sequence databases;
to receive user-action signals from a patient sensor that is operatively coupled to a medical device and generates the user-action signals in response to the that person performing actions on the medical device;
to store in the corresponding time-sequence database, in response to the receipt of the user-action signals, occurrence data corresponding to the actions;
to authorize requests for the occurrence data made over the hierarchical self-similar nodal network; and
to transmit, in response to an authorized request, the occurrence data to another node of the hierarchical self-similar nodal network.

34. A method according to claim 33, wherein said establishing the hierarchical self-similar nodal network includes establishing the hierarchical self-similar nodal network so that the hierarchical self-similar nodal network includes parent nodes and child nodes, wherein every parent node has one or more children nodes but every child node has only one parent node.

35. A method according to claim 33, wherein the patient sensor is configured to retransmit the user-action signals.

36. A method according to claim 33, wherein the medical device is an inhaler including a medicament canister with a first portion and an dispensing device surrounding the medicament canister, and wherein the patient sensor comprises:
a housing coupleable with the first portion of the medicament canister, the housing being sized and configured to avoid contact with the dispensing device during operation of the inhaler;
a switch associated with the housing, the switch being activated by physical pressure and without regard to whether or not medicine is exiting the medicament canister, wherein application of physical pressure to the switch generates the user-action signals; and
a transceiver for transmitting the user-action signals and for receiving a communication from the wearable personal data recorder or another patient sensor.

37. A method according to claim 36, wherein the patient sensor includes a semiconductor logic device connected to the switch for creating and storing information regarding use of the patient sensor.

38. A method according to claim 33, wherein said providing each person with the wearable personal data recorder includes providing each person with a wearable personal data recorder that is further configured to:
receive environmental signals from an environmental sensor that generates the user-environmental signals;
store in the corresponding time-sequence database, in response to the receipt of the environmental signals, environmental data;
authorize requests for the environmental data made over the hierarchical self-similar nodal network; and
transmit, in response to an authorized request, the environmental data to the another node of the hierarchical self-similar nodal network.

39. A method according to claim 38, wherein said providing each person with the wearable personal data recorder includes providing each person with the wearable personal data recorder that includes a global positioning system that generates global positioning coordinates of the wearable personal data recorder and that is further configured to store in the corresponding time-sequence database, in response to the receipt of the environmental signals, global positioning coordinates.

40. A method according to claim 38, wherein said providing each person with the wearable personal data recorder includes providing each person with a wearable personal data recorder that is further configured to, in response to the receipt of the patient signal, store in the corresponding time-sequence database environmental data corresponding to the actions.
